(19) United States
(12) Patent Application Publication
(10) Pub. No.: US 2022/0304229 A1
(43) Pub. Date: Sep. 29, 2022

(54) FEEDERHOUSE ASSEMBLIES, AGRICULTURAL HARVESTERS, AND METHODS OF CONNECTING HARVESTING HEADERS TO AGRICULTURAL HARVESTERS

(71) Applicant: AGCO International GmbH, Neuhausen (CH)

(72) Inventor: Fabio Racchella, Breganze (IT)

(21) Appl. No.: 17/633,572

(22) PCT Filed: Apr. 16, 2020
(86) PCT No.: PCT/EP2020/060693

§ 371 Date: Feb. 7, 2022

Related U.S. Application Data
(60) Provisional application No. 62/882,749, filed on Aug. 5, 2019.

(51) Int. Cl. A01D 41/16; A01D 61/00; F15B 15/14; G01S 17/06

(52) U.S. Cl. CPC A01D 41/16; A01D 61/008; F15B 15/14; G01S 17/06; A01D 67/005

(57) ABSTRACT

A feederhouse assembly (200) for an agricultural harvester (100) includes a feederhouse (200) having an inlet end (204), ea yaw frame (214) adjacent the inlet end (204) and arranged to pivot about a vertical axis (216) relative to the feederhouse (200), and at least one hydraulic cylinder (220) configured to apply a hydraulic force to rotate the yaw frame (214) about the vertical axis (216). A method of connecting a harvesting header to an agricultural harvester includes applying a first hydraulic force from at least one hydraulic cylinder to a yaw frame (214), moving the agricultural harvester toward the harvesting header, securing the harvesting header to the yaw frame (214), and applying a second hydraulic force from the at least one hydraulic cylinder to the yaw frame (214) to orient the harvesting header at a right angle with respect to a longitudinal axis of the agricultural harvester (100).

### CROSS-REFERENCE TO RELATED APPLICATION

This application claims the benefit of the filing date of U.S. Provisional Patent Application 62/882,749, “Feederhouse Assemblies, Agricultural Harvesters, and Methods of Connecting Harvesting Headers to Agricultural Harvesters,” filed Aug. 5, 2019, the entire disclosure of which is incorporated herein by reference.

### FIELD

This disclosure relates to self-propelled crop harvesting machines capable of supporting a harvesting header on the front end thereof, and particularly to a feederhouse that facilitates attachment of a harvesting header to the machine.

### BACKGROUND

Self-propelled agricultural harvesters are well known and include, by way of example, combine harvesters, windrowers, and forage harvesters, all of which typically include a frame or chassis, an operator cab, an engine, and ground-engaging wheels or tracks. A cutting or pick-up header is often carried by the harvester, the header typically being considerably wider than the harvester and mounted to the front side of a feederhouse.

Crop material collected by the header is conveyed into the feederhouse before being conveyed in a generally rearward direction to crop-processing apparatus. In the case of a combine harvester, the processing apparatus serves to thresh the crop material and separate grain therefrom, whereas, in the case of a forage harvester or windrower the crop material is typically passed through conditioning rollers.

The height of the header is typically adjusted by raising and lowering the feeder house around a lateral feederhouse pivot axis. To permit pitch adjustment of the header with respect to the feeder house, a header-interface frame is often pivotally mounted to the feeder house over the front opening thereof to permit pitch adjustment around a transverse pitch-adjustment axis. A hydraulic cylinder controls adjustment of the lateral tilt.

### BRIEF SUMMARY

In some embodiments, a feederhouse assembly for an agricultural harvester includes a feederhouse having an inlet end, a yaw frame adjacent the inlet end of the feederhouse and arranged to pivot about a vertical axis relative to the feederhouse, and at least one hydraulic cylinder configured to apply a hydraulic force to rotate the yaw frame about the vertical axis.

A method of connecting a harvesting header to an agricultural harvester includes applying a first hydraulic force from at least one hydraulic cylinder to a yaw frame adjacent an inlet end of a feederhouse, moving the agricultural harvester toward the harvesting header, securing the harvesting header to the yaw frame, and applying a second hydraulic force from the at least one hydraulic cylinder to the yaw frame to orient the harvesting header at a right angle with respect to a longitudinal axis of the agricultural harvester. The first hydraulic force and second hydraulic force are oriented to pivot the yaw frame about a vertical axis.

An agricultural harvester includes a chassis, a feederhouse coupled to the chassis and comprising an inlet end, a yaw frame adjacent the inlet end of the feederhouse and arranged to pivot about a vertical axis relative to the feederhouse, at least one hydraulic cylinder configured to apply a hydraulic force to rotate the yaw frame about the vertical axis, a processing system carried by the chassis and structured to receive crop material from the feederhouse, and a grain bin carried by the chassis and structured to receive grain from the processing system.

A non-transitory computer-readable storage medium includes instructions that when executed by a computer, cause the computer to apply a first hydraulic force from at least one hydraulic cylinder to a yaw frame adjacent an inlet end of a feederhouse. The first hydraulic force is oriented to pivot the frame about a vertical axis. When the yaw frame is in an orientation corresponding to an orientation of a harvesting header, the computer moves the agricultural harvester toward the harvesting header, secures the harvesting header to the yaw frame, and applies a second hydraulic force from the at least one hydraulic cylinder to the yaw frame to orient the harvesting header at a right angle with respect to a longitudinal axis of the agricultural harvester.

Other embodiments of a method of connecting a harvesting header to an agricultural harvester include directing electromagnetic radiation from a yaw frame adjacent an inlet end of a feederhouse toward the harvesting header, receiving reflected electromagnetic radiation from the harvesting header at the yaw frame, applying a first hydraulic force from at least one hydraulic cylinder to the yaw frame, moving the agricultural harvester toward the harvesting header, securing the harvesting header to the yaw frame, and applying a second hydraulic force from the at least one hydraulic cylinder to the yaw frame to orient the harvesting header perpendicular to a longitudinal axis of the agricultural harvester. The hydraulic forces are oriented to pivot the yaw frame about a vertical axis.

### BRIEF DESCRIPTION OF THE DRAWINGS

While the specification concludes with claims particularly pointing out and distinctly claiming what are regarded as embodiments of the present disclosure, various features and advantages of embodiments of the disclosure may be more readily ascertained from the following description of example embodiments of the disclosure when read in conjunction with the accompanying drawings, in which:

FIG. 1 is a simplified front perspective view of an example agricultural harvester;

FIG. 2 illustrates a feederhouse assembly having a yaw frame, which may be a part of the agricultural harvester shown in FIG. 1;

FIG. 3 is a simplified schematic diagram of a header yaw control system for the feederhouse assembly of FIG. 2;

FIG. 4 is a simplified schematic diagram of another header yaw control system that may be used with the feederhouse assembly of FIG. 2;

FIG. 5A is a simplified top view of an agricultural harvester approaching a harvesting header;

FIG. 5B is a simplified top view of the agricultural harvester connected to the harvesting header;

FIG. 5C is a simplified top view of the agricultural harvester connected to the harvesting header after the harvesting header has been moved to a harvesting position;

FIG. 6 is a simplified flow chart illustrating an example method of connecting a harvesting header to an agricultural harvester; and

FIG. 7 illustrates an example computer-readable storage medium comprising processor-executable instructions configured to embody a method of connecting a harvesting header to an agricultural harvester, such as the method illustrated in FIG. 6.

### DETAILED DESCRIPTION

The illustrations presented herein are not actual views of any agricultural harvester or portion thereof, but are merely idealized representations that are employed to describe example embodiments of the present disclosure. Additionally, elements common between figures may retain the same numerical designation.

The following description provides specific details of embodiments of the present disclosure in order to provide a thorough description thereof. However, a person of ordinary skill in the art will understand that the embodiments of the disclosure may be practiced without employing many such specific details. Indeed, the embodiments of the disclosure may be practiced in conjunction with conventional techniques employed in the industry. In addition, the description provided below does not include all elements to form a complete structure or assembly. Only those process acts and structures necessary to understand the embodiments of the disclosure are described in detail below. Additional conventional acts and structures may be used. Also note, the drawings accompanying the application are for illustrative purposes only, and are thus not drawn to scale.

As used herein, the terms “comprising,” “including,” “containing,” “characterized by,” and grammatical equivalents thereof are inclusive or open-ended terms that do not exclude additional, unrecited elements or method steps, but also include the more restrictive terms “consisting of” and “consisting essentially of” and grammatical equivalents thereof.

As used herein, the term “may” with respect to a material, structure, feature, or method act indicates that such is contemplated for use in implementation of an embodiment of the disclosure, and such term is used in preference to the more restrictive term “is” so as to avoid any implication that other, compatible materials, structures, features, and methods usable in combination therewith should or must be excluded.

As used herein, the term “configured” refers to a size, shape, material composition, and arrangement of one or more of at least one structure and at least one apparatus facilitating operation of one or more of the structure and the apparatus in a predetermined way.

As used herein, the singular forms following “a,” “an,” and “the” are intended to include the plural forms as well, unless the context clearly indicates otherwise.

As used herein, the term “and/or” includes any and all combinations of one or more of the associated listed items.

As used herein, spatially relative terms, such as “beneath,” “below,” “lower,” “bottom,” “above,” “upper,” “top,” “front,” “rear,” “left,” “right,” and the like, may be used for ease of description to describe one element's or feature's relationship to another element(s) or feature(s) as illustrated in the figures. Unless otherwise specified, the spatially relative terms are intended to encompass different orientations of the materials in addition to the orientation depicted in the figures.

As used herein, the term “substantially” in reference to a given parameter, property, or condition means and includes to a degree that one of ordinary skill in the art would understand that the given parameter, property, or condition is met with a degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” used in reference to a given parameter is inclusive of the stated value and has the meaning dictated by the context (e.g., it includes the degree of error associated with measurement of the given parameter).

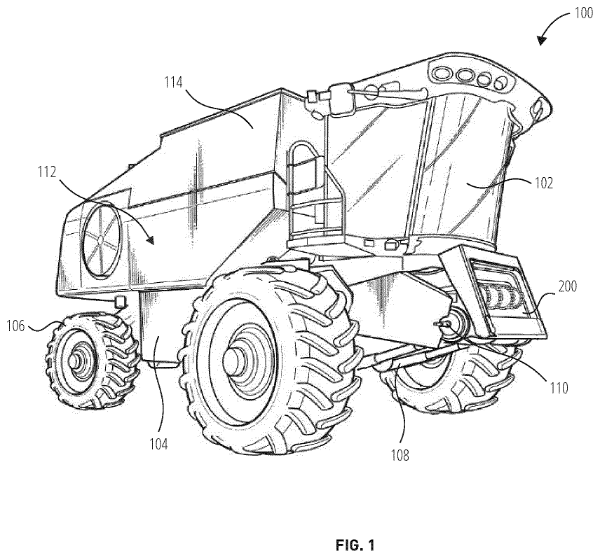

FIG. 1 illustrates an example agricultural harvester embodied as a combine harvester 100. In the context of the present disclosure, the example combine harvester 100 is merely illustrative, and other machines and/or implements with like functionality may deploy certain embodiments disclosed herein, such as windrowers, forage harvesters, etc. The example combine harvester 100 is shown in FIG. 1 without a header attached, and includes a feederhouse assembly 200 carried by a chassis 104 supported by wheels 106. An operator cab 102 is mounted to the chassis 104. In some embodiments, other or additional forms of travel may be used, such as tracks. Hydraulic cylinders 108 are shown affixed to the underside of the feederhouse assembly 200 on one end and to the chassis 104 on the other end. The feederhouse assembly 200 may move (e.g., up and down, tilt, etc.) based on actuation of the hydraulic cylinders 108, which causes a detachably coupled header to also be raised, lowered, and/or tilted. A rotating shaft 110 may be configured to provide mechanical power to a header during operation of the combine harvester 100. The rotating shaft 110 may be configured to operate at various speeds, as described in, for example, U.S. Pat. No. 9,434,252, “Power Takeoff Drive System for a Vehicle,” issued Sep. 6, 2016.

In general, the combine harvester 100 cuts crop materials (e.g., using the header), wherein the cut crop materials are delivered to the front end of the feederhouse assembly 200. Such crop materials are moved upwardly and rearwardly within and beyond the feederhouse assembly 200 (e.g., by a conveyer) until reaching a processing system 112 comprising a thresher rotor. In one embodiment, the thresher rotor may comprise a single, transverse rotor, such as that found in a Gleaner® Super Series Combine by AGCO. Other designs may be used, such as axial-based, twin rotor, or hybrid designs. The thresher rotor processes the crop materials in known manner and passes a portion of the crop material (e.g., heavier chaff, corn stalks, etc.) toward the rear of the combine harvester 100 and another portion (e.g., grain and possibly light chaff) through a cleaning process in known manner. In the processing system 112, the crop materials undergo threshing and separating operations. In other words, the crop materials are threshed and separated by the thresher rotor operating in cooperation with well-known foraminous processing members in the form of threshing concave assemblies and separator grate assemblies, with the grain (and possibly light chaff) escaping through the concave assemblies and the grate assemblies and to a cleaning system located beneath the processor to facilitate the cleaning of the heavier crop material. Bulkier stalk and leaf materials are generally retained by the concave assemblies and the grate assemblies and are discharged out from the processing system 112 and ultimately out of the rear of the combine harvester 100. The cleaned grain that drops to the bottom of the cleaning system is delivered by a conveying mechanism that transports the grain to an elevator, which conveys the grain to a grain bin 114 located at the top of the combine harvester 100. Any remaining chaff and partially or unthreshed grain is recirculated through the processing system 112 via a tailings return conveying mechanism. Because combine processing is known to those having ordinary skill in the art, further discussion thereof is omitted here for brevity. In embodiments in which the agricultural harvester is a windrower or forage harvester, the processing system 112 may include conditioning rollers, rather than separation devices.

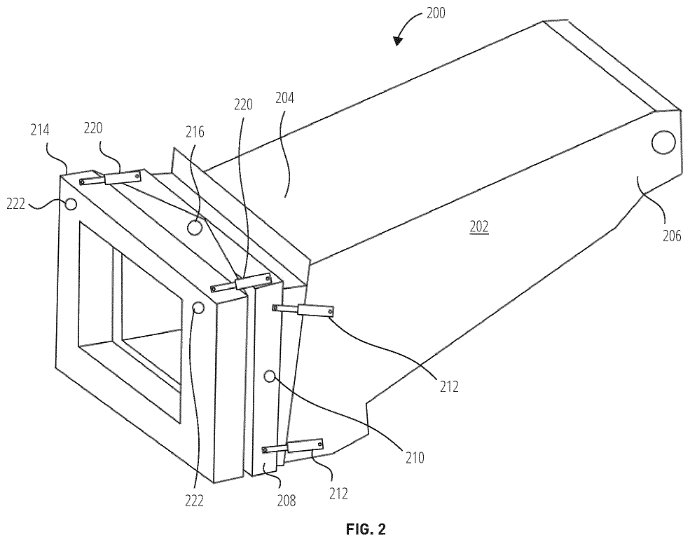

FIG. 2 is a simplified perspective view of the feederhouse assembly 200 of the combine harvester 100 shown in FIG. 1. As shown, a feederhouse 202 has an inlet end 204 and an outlet end 206. Crop material entering the feederhouse assembly 200 from the harvesting header travels from the inlet end 204 toward the outlet end 206 on the way to the processing system 112 (FIG. 1). The harvesting header is coupled to the feederhouse 202 by a yaw frame 214 and a pitch frame 208, which are each adjustable to control the orientation of the harvesting header with respect to the combine harvester 100.

Control of the harvesting header is important to enable a farmer to properly harvest crops. Adjustment of the yaw frame 214 and the pitch frame 208 also facilitates connecting and disconnecting the harvesting header because the yaw frame 214 and the pitch frame 208 can be positioned to match the orientation of the harvesting header.

The pitch frame 208 is adjusted by pivoting about a transverse axis 210. One or more hydraulic cylinders 212 are configured to apply forces on the pitch frame 208 (referred to herein as hydraulic forces, though the forces acting on the pitch frame 208 are due to movement of a piston of the hydraulic cylinders 212, rather than by direct contact of hydraulic fluid on the pitch frame 208). Hydraulic forces are applied to the pitch frame 208 in a direction to rotate the pitch frame 208 upward or downward about the transverse axis 210. Pitch control of a harvesting header is described in more detail in U.S. Pat. No. 10,257,979, “Harvester Header Pitch Adjustment Apparatus,” issued Apr. 16, 2019.

The yaw frame 214 is adjusted by pivoting about a vertical axis 216. Though described as “vertical,” the vertical axis 216 need not be oriented perfectly vertical. As the pitch frame 208 and the combine harvester 100 move, the orientation of the vertical axis 216 may change. The vertical axis 216 is nonetheless defined as the axis about which the yaw frame 214 pivots. One or more hydraulic cylinders 220 are configured to apply forces (i.e., hydraulic forces) on the yaw frame 214. The hydraulic forces are applied to the yaw frame 214 in a direction to rotate the yaw frame 214 left or right about the vertical axis 216.

Two of each of the hydraulic cylinders 212 and the hydraulic cylinders 220 are shown in FIG. 2. Typically, the hydraulic cylinders 212 and the hydraulic cylinders 220 may be single-action hydraulic cylinders, such that each applies a hydraulic force in one direction only. Thus, two of each of hydraulic cylinders 212 and hydraulic cylinders 220 may be necessary to move the yaw frame 214 and/or the pitch frame 208 in opposite directions. In other embodiments, the hydraulic cylinders 212 and/or the hydraulic cylinders 220 may be double-action hydraulic cylinders configured to apply the hydraulic force in two opposing directions, and thus only one of each may be required (i.e., one of hydraulic cylinders 212 and one of hydraulic cylinders 220). In some embodiments, downward motion of the pitch frame 208 may be driven by gravity and the weight of the harvesting header on the pitch frame 208, and thus, only one single-action hydraulic cylinder may be used in place of the hydraulic cylinders 212 acting on the pitch frame 208.

The yaw frame 214 may house one or more transceivers 222, each having an electromagnetic transmitter and an electromagnetic sensor. The transceivers 222 may be configured to provide electromagnetic radiation directed toward the harvesting header. The harvesting header may reflect the electromagnetic radiation, and the transceivers 222 may determine the location and/or orientation of the harvesting header based on the sensed electromagnetic radiation. The electromagnetic radiation may be selected to be, for example, visible laser light or an RF signal (i.e., radio waves). The electromagnetic radiation may enable identification of the location and orientation of the harvesting header when the harvesting header is approximately 1 meter from the transceivers 222. In some embodiments, the yaw frame 214 may carry separate electromagnetic transmitters and electromagnetic sensors.

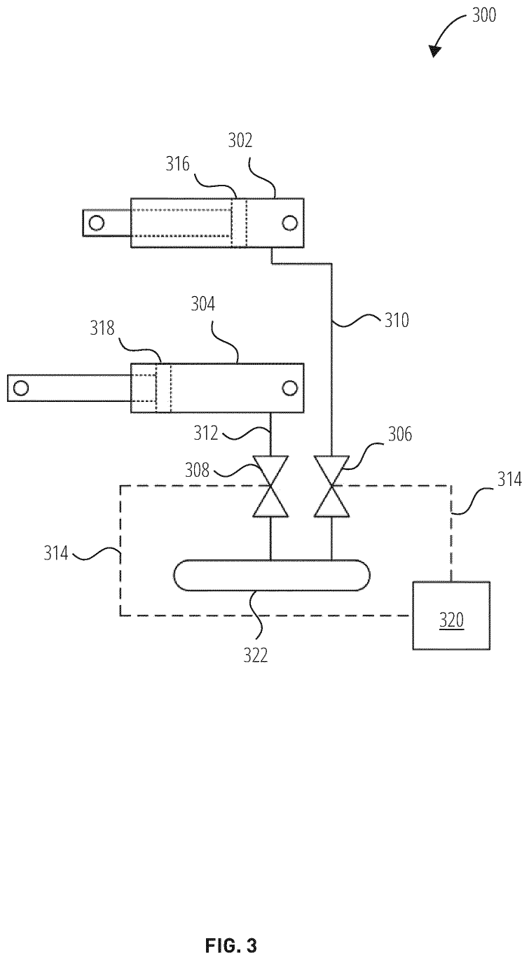

The hydraulic cylinders 220 shown in FIG. 2 may be controlled by a control system 300 as depicted in FIG. 3. In FIG. 3, the hydraulic cylinders 220 are referred to individually as hydraulic cylinder 302 and hydraulic cylinder 304, of which hydraulic cylinder 302 may be on the right of the yaw frame 214, and hydraulic cylinder 304 may be on the left of the yaw frame 214. The hydraulic cylinders 302, 304 each have pistons 316, 318 coupled to the yaw frame 214 and configured to move within the hydraulic cylinders 302, 304. The hydraulic cylinders 302, 304 are controlled by a controller 320 and suitable hydraulic control components as will be known to those skilled in the art.

The control system 300 includes a control valve 306 and a control valve 308 connected to the controller 320 by signal lines 314 (e.g., wires). The control valve 306 and control valve 308 modify the pressure of hydraulic fluid in hydraulic lines 310 and 312, respectively. When open, the control valves 306 and 308 permit pressurized fluid from a pressurized fluid source 322 to flow to the hydraulic cylinders 302 and 304, respectively.

For example, to drive the hydraulic cylinders 302, 304 to the position shown in FIG. 3, which corresponds to orientation of the yaw frame 214 (FIG. 2) angled to the right, the control valve 308 may be opened. Pressurized fluid may then flow through the hydraulic line 312 to drive the piston 318 of the hydraulic cylinder 304 outward. The yaw frame 214 pivots about the vertical axis 216 and pushes the piston 316 of the through hydraulic cylinder 302 inward. To drive the hydraulic cylinders 302, 304 in the opposite direction, the control valve 308 may be closed and the control valve 306 may be opened.

The controller 320 may be a part of a control system for the combine harvester 100, and may be located in or near the operator cab 102.

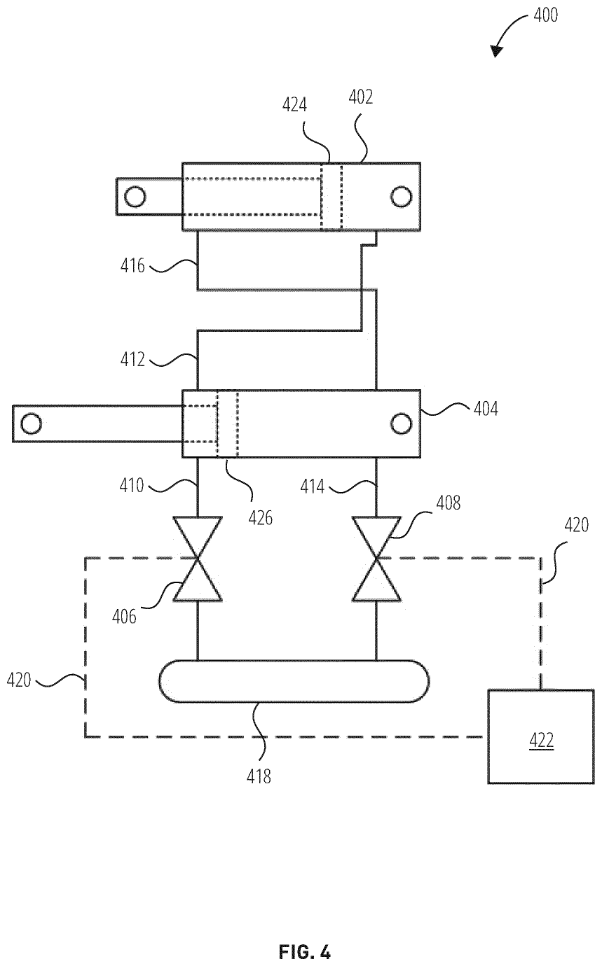

FIG. 4 depicts another control system 400 that may be used to control the hydraulic cylinders 220 shown in FIG. 2. In FIG. 4, the hydraulic cylinders 220 are referred to individually as hydraulic cylinder 402 and hydraulic cylinder 404, of which hydraulic cylinder 402 may be on the right of the yaw frame 214, and hydraulic cylinder 404 may be on the left of the yaw frame 214. The hydraulic cylinders 402, 404 each have pistons 424, 426 coupled to the yaw frame 214 and configured to move within the hydraulic cylinders 402, 404. The hydraulic cylinders 402, 404 are controlled by a controller 422 and suitable hydraulic control components as will be known to those skilled in the art.

The control system 400 may include a control valve 406 and a control valve 408 connected to the controller 422 by signal lines 420 (e.g., wires). The control valves 406, 408 modify the pressure of hydraulic fluid in hydraulic lines 410, 412, 416, and 414. When open, the control valves 406, 408 permit pressurized fluid from a pressurized fluid source 418 to flow to the hydraulic cylinders 402, 404.

For example, to drive the hydraulic cylinders 402, 404 to the position shown in FIG. 4, which corresponds to the yaw frame 214 (FIG. 2) oriented to the right, the control valve 408 may be opened. Pressurized fluid may then flow through the hydraulic line 414 to drive the piston 426 of the hydraulic cylinder 404 outward and through the hydraulic line 416 to drive to piston 424 of the hydraulic cylinder 402 inward. To drive the hydraulic cylinders 402, 404 in the opposite direction, the control valve 408 may be closed and the control valve 406 may be opened.

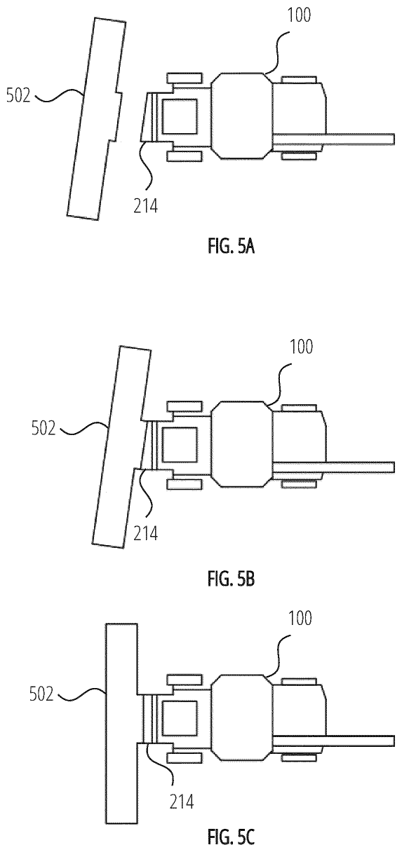

FIGS. 5A through 5C show how a harvesting header 502 may be connected to the combine harvester 100. As the combine harvester 100 approaches the harvesting header 502, the yaw frame 214 may be adjusted such that the yaw frame 214 is parallel to the harvesting header 502, as depicted in FIG. 5A. The combine harvester 100 may then continue forward to couple the harvesting header 502 with the yaw frame 214, as shown in FIG. 5B. Once the harvesting header 502 is connected, the yaw frame 214 may rotate the harvesting header 502 to a selected orientation for harvesting, typically perpendicular to (i.e., at a right angle with) a longitudinal axis parallel to a direction of travel of the combine harvester 100.

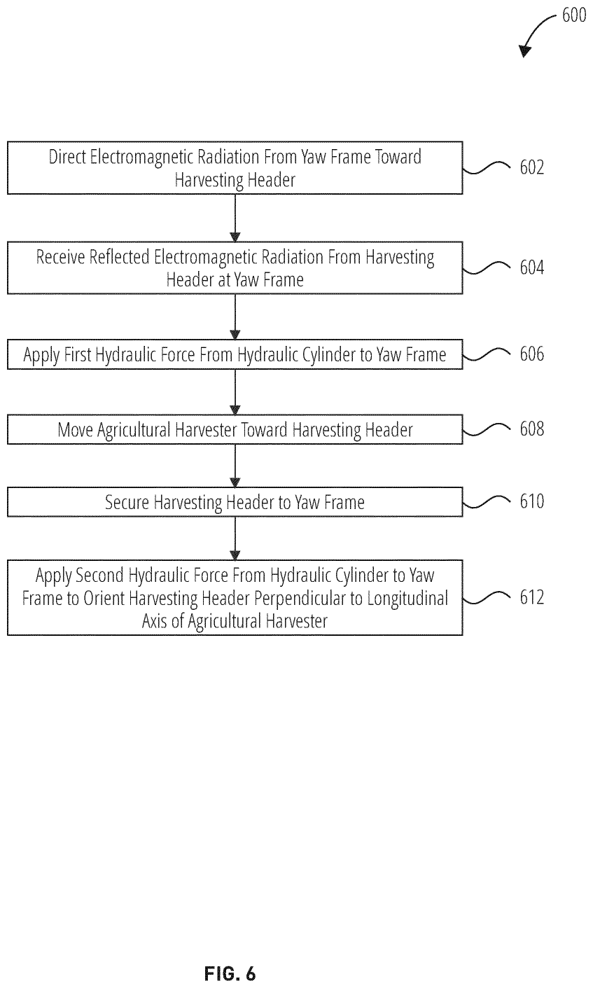

FIG. 6 is a simplified flow chart illustrating a method 600 of connecting a harvesting header to an agricultural harvester, such as the combine harvester 100 shown in FIG. 1 and having a feederhouse assembly 200 as shown in FIG. 2. As shown in block 602, electromagnetic radiation may be directed from a yaw frame adjacent an inlet end of a feederhouse toward the harvesting header.

In block 604, reflected electromagnetic radiation may be received from the harvesting header at the yaw frame. The reflected electromagnetic radiation may be used to determine the orientation of the harvesting header and/or the distance from the yaw frame to the harvesting header. Blocks 602 and 604 are optional, and may occur simultaneously.

In block 606, a first hydraulic force is applied from at least one hydraulic cylinder to the yaw frame to pivot the yaw frame about a vertical axis. The first hydraulic force may be applied by providing a pressurized fluid to the at least one hydraulic cylinder.

In block 608, the agricultural harvester moves toward the harvesting header. Block 606 and block 608 may occur at the same time or may occur in any order.

In block 610, the harvesting header is secured to the yaw frame. For example, a computer may be configured to cause mechanical coupling between the yaw frame and the harvesting header without intervention by any person located proximal to the coupling location because the yaw frame may be aligned with the harvesting header. When the yaw frame is near the harvesting header, sensors may detect the orientation and position of the harvesting header and of the yaw frame (e.g., using the radiation optionally received in block 604). The computer may adjust the pressure provided to the hydraulic cylinder(s) to match the orientation of the yaw frame to the orientation of the harvesting header. The computer may then alert an operator to move the agricultural harvester forward until it meets the harvesting header, or may provide a signal to the control system of the agricultural harvester to perform this action automatically. Thus, the harvesting header may be connected without requiring the operator to make any measurements or adjustments at the point of connection. This may increase safety by enabling the operator to remain away from pinch points. Connecting harvesting headers is described in further detail in U.S. Pat. No. 10,034,425, “Automatic Header Coupling,” issued Jul. 31, 2018.

In block 612, a second hydraulic force is applied from the at least one hydraulic cylinder to the yaw frame to orient the harvesting header perpendicular to a longitudinal axis of the agricultural harvester. Thus, the agricultural harvester and the harvesting header are ready for harvesting.

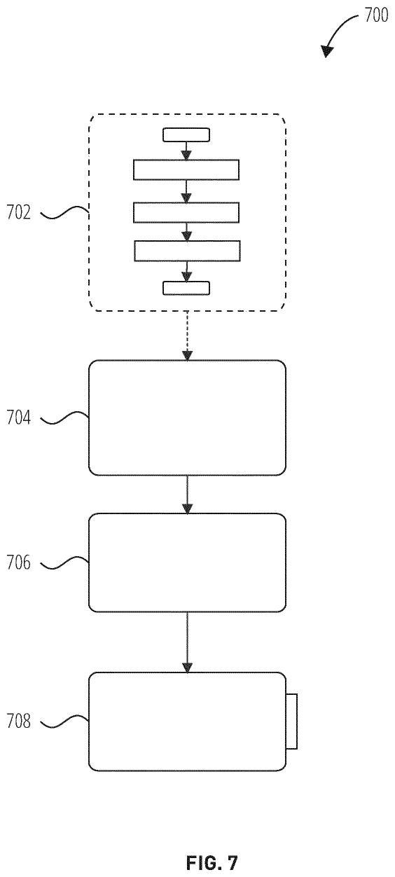

Still other embodiments involve a computer-readable storage medium (e.g., a non-transitory computer-readable storage medium) having processor-executable instructions configured to implement one or more of the techniques presented herein. An example computer-readable medium that may be devised is illustrated in FIG. 7, wherein an implementation 700 includes a computer-readable storage medium 702 (e.g., a flash drive, CD-R, DVD-R, application-specific integrated circuit (ASIC), field-programmable gate array (FPGA), a platter of a hard disk drive, etc.), on which is computer-readable data 704. This computer-readable data 704 in turn includes a set of processor-executable instructions 706 configured to operate according to one or more of the principles set forth herein. In some embodiments, the processor-executable instructions 706 may be configured to cause a computer to perform operations 708 when executed via a processing unit, such as at least some of the example method 600 depicted in FIG. 6. Many such computer-readable media may be devised by those of ordinary skill in the art that are configured to operate in accordance with one or more of the techniques presented herein.

An advantage of including a yaw control in the feederhouse assembly disclosed herein is that the agricultural harvester can be better aligned with the harvesting header. This may simplify connection of the harvesting header with the agricultural harvester, and may improve safety.

Additional non-limiting example embodiments of the disclosure are described below.

Embodiment 1: A feederhouse assembly for an agricultural harvester comprising a feederhouse comprising an inlet end, a yaw frame adjacent the inlet end of the feederhouse and arranged to pivot about a vertical axis relative to the feederhouse, and at least one hydraulic cylinder configured to apply a hydraulic force to rotate the yaw frame about the vertical axis.

Embodiment 2: The feederhouse assembly of Embodiment 1, wherein the at least one hydraulic cylinder comprises a first hydraulic cylinder and a second hydraulic cylinder, wherein the first hydraulic cylinder is positioned to apply the hydraulic force in an opposite direction to the second hydraulic cylinder.

Embodiment 3: The feederhouse assembly of Embodiment 2, wherein the first hydraulic cylinder and the second hydraulic cylinder each comprise single-action hydraulic cylinders.

Embodiment 4: The feederhouse assembly of any one of Embodiment 1 through Embodiment 3, further comprising a control valve configured to modify pressure of a hydraulic fluid in the at least one hydraulic cylinder.

Embodiment 5: The feederhouse assembly of Embodiment 4, further comprising a controller configured to operate the control valve.

Embodiment 6: The feederhouse assembly of Embodiment 5, wherein the controller is configured to cause mechanical coupling between the yaw frame and a harvesting header without intervention by any person located proximal to a coupling location thereof.

Embodiment 7: The feederhouse assembly of any one of Embodiment 1 through Embodiment 6, further comprising at least one electromagnetic sensor coupled to the yaw frame.

Embodiment 8: The feederhouse assembly of Embodiment 7, further comprising at least one electromagnetic transmitter configured to transmit electromagnetic radiation such that, when the frame is in proximity to a harvesting header, the electromagnetic radiation reflects off the harvesting header toward the at least one electromagnetic sensor.

Embodiment 9: The feederhouse assembly of Embodiment 8, wherein the at least one electromagnetic transmitter comprises a laser.

Embodiment 10: The feederhouse assembly of Embodiment 8 or Embodiment 9, wherein the at least one electromagnetic sensor and the at least one electromagnetic transmitter together comprise a transceiver.

Embodiment 11: The feederhouse assembly of any one of Embodiment 7 through Embodiment 10, wherein the at least one electromagnetic sensor comprises a first electromagnetic sensor and a second electromagnetic sensor, wherein the first electromagnetic sensor is positioned on an opposite side of the frame from the second electromagnetic sensor.

Embodiment 12: The feederhouse assembly of any one of Embodiment 1 through Embodiment 11, further comprising a pitch frame adjacent the inlet end of the feederhouse and arranged to pivot about a transverse axis relative to the feederhouse, and at least one additional hydraulic cylinder configured to apply an additional hydraulic force to rotate the pitch frame about the transverse axis.

Embodiment 13: The feederhouse assembly of Embodiment 12, wherein the yaw frame is coupled to the pitch frame at the vertical axis, and wherein the pitch frame is coupled to the feederhouse at the transverse axis.

Embodiment 14: A method of connecting a harvesting header to an agricultural harvester comprising applying a first hydraulic force from at least one hydraulic cylinder to a yaw frame adjacent an inlet end of a feederhouse, moving the agricultural harvester toward the harvesting header, securing the harvesting header to the yaw frame, and applying a second hydraulic force from the at least one hydraulic cylinder to the yaw frame to orient the harvesting header at a right angle with respect to a longitudinal axis of the agricultural harvester. The first hydraulic force and second hydraulic force are oriented to pivot the yaw frame about a vertical axis.

Embodiment 15: The method of Embodiment 14, wherein applying the first hydraulic force and applying the second hydraulic force each comprise providing a pressurized fluid to the at least one hydraulic cylinder.

Embodiment 16: The method of Embodiment 14 or Embodiment 15, wherein securing the harvesting header to the yaw frame comprises securing the harvesting header to the yaw frame without intervention by any person located proximal to a coupling location thereof.

Embodiment 17: The method of any one of Embodiment 14 through Embodiment 16, further comprising directing electromagnetic radiation from the yaw frame toward the harvesting header and receiving reflected electromagnetic radiation from the harvesting header at the yaw frame.

Embodiment 18: An agricultural harvester comprising a chassis, a feederhouse coupled to the chassis and comprising an inlet end, a yaw frame adjacent the inlet end of the feederhouse and arranged to pivot about a vertical axis relative to the feederhouse, at least one hydraulic cylinder configured to apply a hydraulic force to rotate the yaw frame about the vertical axis, a processing system carried by the chassis and structured to receive crop material from the feederhouse, and a grain bin carried by the chassis and structured to receive grain from the processing system.

Embodiment 19: A non-transitory computer-readable storage medium, the computer-readable storage medium including instructions that when executed by a computer, cause the computer to apply a first hydraulic force from at least one hydraulic cylinder to a yaw frame adjacent an inlet end of a feederhouse of an agricultural harvester. The first hydraulic force is oriented to pivot the frame about a vertical axis. When the yaw frame is in an orientation corresponding to an orientation of a harvesting header, the computer moves the agricultural harvester toward the harvesting header, secures the harvesting header to the yaw frame, and applies a second hydraulic force from the at least one hydraulic cylinder to the yaw frame to orient the harvesting header at a right angle with respect to a longitudinal axis of the agricultural harvester.

Embodiment 20: A method of connecting a harvesting header to an agricultural harvester, the method comprising directing electromagnetic radiation from a yaw frame adjacent an inlet end of a feederhouse toward the harvesting header, receiving reflected electromagnetic radiation from the harvesting header at the yaw frame, applying a first hydraulic force from at least one hydraulic cylinder to the yaw frame, moving the agricultural harvester toward the harvesting header, securing the harvesting header to the yaw frame, and applying a second hydraulic force from the at least one hydraulic cylinder to the yaw frame to orient the harvesting header perpendicular to a longitudinal axis of the agricultural harvester. The hydraulic forces are oriented to pivot the yaw frame about a vertical axis.

All references cited herein are incorporated herein in their entireties. If there is a conflict between definitions herein and in an incorporated reference, the definition herein shall control.

While the present disclosure has been described herein with respect to certain illustrated embodiments, those of ordinary skill in the art will recognize and appreciate that it is not so limited. Rather, many additions, deletions, and modifications to the illustrated embodiments may be made without departing from the scope of the disclosure as hereinafter claimed, including legal equivalents thereof. In addition, features from one embodiment may be combined with features of another embodiment while still being encompassed within the scope as contemplated by the inventors. Further, embodiments of the disclosure have utility with different and various machine types and configurations.

1. A feederhouse assembly for an agricultural harvester, the feederhouse assembly comprising:
a feederhouse comprising an inlet end;
a yaw frame adjacent the inlet end of the feederhouse and arranged to pivot about a vertical axis relative to the feederhouse; and
at least one hydraulic cylinder configured to apply a hydraulic force to rotate the yaw frame about the vertical axis.

2. The feederhouse assembly of claim 1, wherein the at least one hydraulic cylinder comprises a first hydraulic cylinder and a second hydraulic cylinder, wherein the first hydraulic cylinder is positioned to apply the hydraulic force in an opposite direction to the second hydraulic cylinder.

3. The feederhouse assembly of claim 2, wherein the first hydraulic cylinder and the second hydraulic cylinder each comprise single-action hydraulic cylinders.

4. The feederhouse assembly of claim 1, further comprising a control valve configured to modify pressure of a hydraulic fluid in the at least one hydraulic cylinder.

5. The feederhouse assembly of claim 4, further comprising a controller configured to operate the control valve.

6. The feederhouse assembly of claim 5, wherein the controller is configured to cause mechanical coupling between the yaw frame and a harvesting header without intervention by any person located proximal to a coupling location thereof.

7. The feederhouse assembly of claim 1, further comprising at least one electromagnetic sensor coupled to the yaw frame.

8. The feederhouse assembly of claim 7, further comprising at least one electromagnetic transmitter configured to transmit electromagnetic radiation such that, when the frame is in proximity to a harvesting header, the electromagnetic radiation reflects off the harvesting header toward the at least one electromagnetic sensor.

9. The feederhouse assembly of claim 8, wherein the at least one electromagnetic transmitter comprises a laser.

10. The feederhouse assembly of claim 8, wherein the at least one electromagnetic sensor and the at least one electromagnetic transmitter together comprise a transceiver.

11. The feederhouse assembly of claim 7, wherein the at least one electromagnetic sensor comprises a first electromagnetic sensor and a second electromagnetic sensor, wherein the first electromagnetic sensor is positioned on an opposite side of the frame from the second electromagnetic sensor.

12. The feederhouse assembly of claim 1, further comprising:
a pitch frame adjacent the inlet end of the feederhouse and arranged to pivot about a transverse axis relative to the feederhouse; and
at least one additional hydraulic cylinder configured to apply an additional hydraulic force to rotate the pitch frame about the transverse axis.

13. The feederhouse assembly of claim 12, wherein the yaw frame is coupled to the pitch frame at the vertical axis, and wherein the pitch frame is coupled to the feederhouse at the transverse axis.

14. A method of connecting a harvesting header to an agricultural harvester, the method comprising:
applying a first hydraulic force from at least one hydraulic cylinder to a yaw frame adjacent an inlet end of a feederhouse, the first hydraulic force oriented to pivot the yaw frame about a vertical axis;
moving the agricultural harvester toward the harvesting header;
securing the harvesting header to the yaw frame; and
applying a second hydraulic force from the at least one hydraulic cylinder to the yaw frame to orient the harvesting header at a right angle with respect to a longitudinal axis of the agricultural harvester.

15. The method of claim 14, wherein applying the first hydraulic force and applying the second hydraulic force each comprise providing a pressurized fluid to the at least one hydraulic cylinder.

16. The method of claim 14, wherein securing the harvesting header to the yaw frame comprises securing the harvesting header to the yaw frame without intervention by any person located proximal to a coupling location thereof.

17. The method of claim 14, further comprising directing electromagnetic radiation from the yaw frame toward the harvesting header and receiving reflected electromagnetic radiation from the harvesting header at the yaw frame.

18. An agricultural harvester, comprising:
a chassis;
the feederhouse assembly of claim 1 coupled to the chassis;
a processing system carried by the chassis and structured to receive crop material from the feederhouse assembly; and
a grain bin carried by the chassis and structured to receive grain from the processing system.

19. A non-transitory computer-readable storage medium, the computer-readable storage medium including instructions that when executed by a computer, cause the computer to perform the method of claim 14.
